(19) United States
(12) Patent Application Publication
(10) Pub. No.: US 2025/0063343 A1
(43) Pub. Date: Feb. 20, 2025

(54) IDENTITY-FREE LOCATION STATE

(71) Applicant: QUALCOMM Incorporated, San Diego, CA (US)

(72) Inventors: Joel MORRIN, North Reading, MA (US); Robert ANDERSON, Bryn Mawr, PA (US)

(21) Appl. No.: 18/452,487

(22) Filed: Aug. 18, 2023

(51) Int. Cl. H04W 12/02; H04W 12/63

(52) U.S. Cl. CPC H04W 12/02; H04W 12/63

(57) ABSTRACT

Apparatus, methods, and computer program products for providing location to a device without explicitly identifying the device are provided. An example method may include transmitting, for a location server, a location request including a first state token associated with the device, wherein the location request does not include an identifier associated with the device. The example method may further include receiving, from the location server based on the location request, a location response including a second state token associated with the device.

### TECHNICAL FIELD

The present disclosure relates generally to communication systems, and more particularly, to wireless communication systems with a location server that may be providing location service to devices.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies. The improvements may also be applicable to devices based on wired communications.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus associated with a device are provided. The apparatus may include at least one memory and at least one processor coupled to the at least one memory. Based at least in part on information stored in the at least one memory, the at least one processor, individually or in any combination, is configured to transmit, for a location server, a location request including a first state token associated with the device, where the location request does not include an identifier associated with the device. Based at least in part on information stored in the at least one memory, the at least one processor, individually or in any combination, is configured to receive, from the location server based on the location request, a location response including a second state token associated with the device.

In another aspect of the disclosure, a method, a computer-readable medium, and an apparatus at a location server are provided. The apparatus may include at least one memory and at least one processor coupled to the at least one memory. Based at least in part on information stored in the at least one memory, the at least one processor, individually or in any combination, is configured to receive, a location request including a first state token associated with the device, where the location request does not include an identifier associated with the device. Based at least in part on information stored in the at least one memory, the at least one processor, individually or in any combination, is configured to transmit, based on the location request, a location response including a second token associated with the device.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating an example of processing a location request and providing a location response based on a state token.

FIG. 6 is a diagram illustrating an example of processing a location request and providing a location response based on a state token including a state identifier (ID).

FIG. 7 is a diagram illustrating an example of an architecture associated with providing location information to a device.

FIG. 8 is a diagram illustrating example communications between a location server and a device.

FIG. 9 is a flowchart of a method of providing location information.

FIG. 10 is a flowchart of a method of providing location information.

FIG. 11 is a diagram illustrating an example of a hardware implementation for an example apparatus and/or network entity.

FIG. 12 is a diagram illustrating an example of a hardware implementation for an example network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

A location server may provide a location associated with a device to the device, such as by transmitting location information associated with the device via one or more intermediary servers, network entities, network nodes, or the like. A location server may be able to provide a more accurate location based on more advanced or complicated location technologies compared to a location determined by the device itself. To ensure security and privacy associated with a location request, aspects provided herein may encode information for providing the location into a state token in a location request, and the location server may respond with another state token. By way of example, the state token may include a location history, uncertainties, confidence metrics, historical location related measurements associated with the device (which may include measurements made by the network work device or measurements made by other entities based on signals transmitted by the device), state machine values, probabilities, and aggregations of these values, or the like. The state token may be persisted (e.g., stored) at the device (e.g., or a separate device associated with the device that is not located at the device or the location server) but not the location server, enabling location servers based on state tokens that do not include a device identifier associated with the device.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

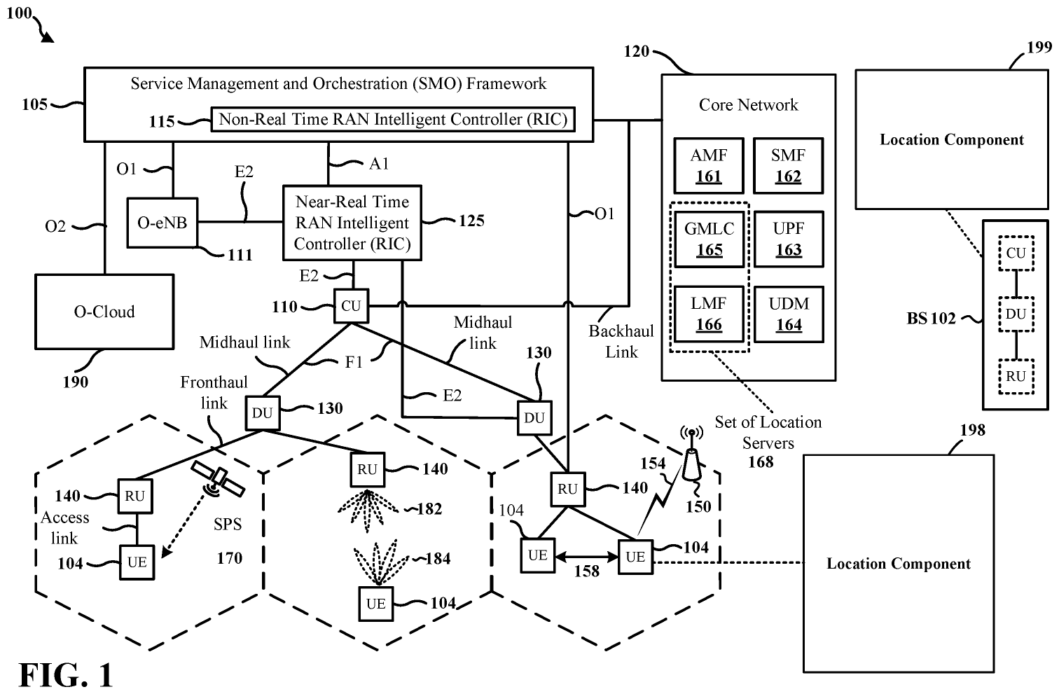

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an AI interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as AI policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a location component 198. In some aspects, the location component 198 may be configured to transmit, for a location server, a location request including a first state token associated with the device, where the location request does not include an identifier associated with the device. In some aspects, the location component 198 may be further configured to receive, from the location server based on the location request, a location response including a second state token associated with the device.

In certain aspects, the base station 102 may be in communication with a location component 199. In some aspects, the location component 199 may be configured to receive, a location request including a first state token associated with the device, where the location request does not include an identifier associated with the device. In some aspects, the location component 199 may be further configured to transmit, based on the location request, a location response including a second token associated with the device.

Although the following description may be focused on 5G NR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

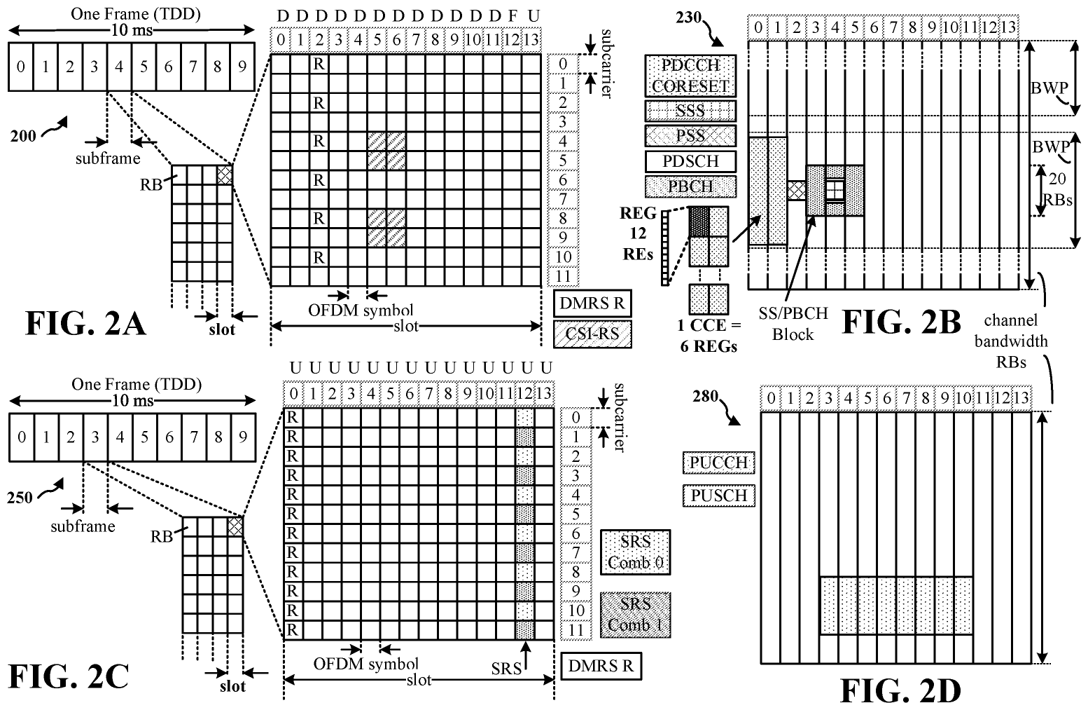

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2 slots/subframe. The subcarrier spacing may be equal to 2*15 kHz where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 s. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

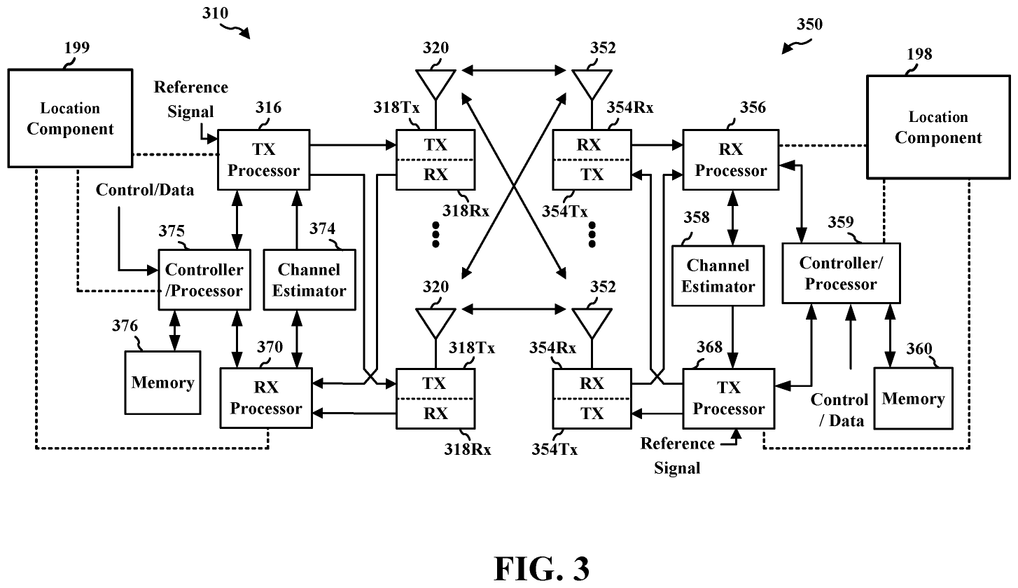

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with location component 198 of FIG. 1.

At least one of the TX processor 316, the RX processor 370, and the controller/processor 375 may be configured to perform aspects in connection with location component 199 of FIG. 1.

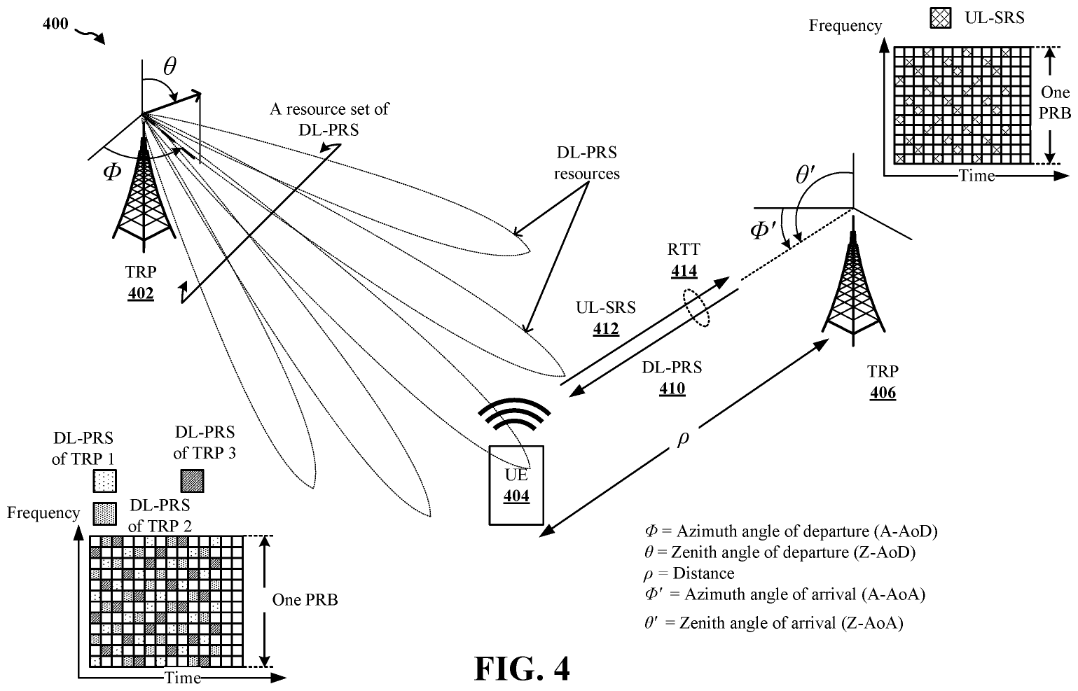

FIG. 4 is a diagram 400 illustrating an example of a UE positioning based on reference signal measurements. The UE 404 may transmit UL-SRS 412 at time T_{SRS_TX} and receive DL positioning reference signals (PRS) (DL-PRS) 410 at time T_{PRS_RX}. The TRP 406 may receive the UL-SRS 412 at time T_{SRS_RX} and transmit the DL-PRS 410 at time T_{PRS_TX}. The UE 404 may receive the DL-PRS 410 before transmitting the UL-SRS 412, or may transmit the UL-SRS 412 before receiving the DL-PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL-SRS-RSRP at multiple TRPs 402, 406 of uplink signals transmitted from UE 404. The UE 404 measures the UE Rx-Tx time difference measurements (and optionally DL-PRS-RSRP of the received signals) using assistance data received from the positioning server, and the TRPs 402, 406 measure the gNB Rx-Tx time difference measurements (and optionally UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and optionally DL-PRS-RSRP) of downlink signals received from multiple TRPs 402, 406 at the UE 404. The UE 404 measures the DL RSTD (and optionally DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and optionally UL-SRS-RSRP) at multiple TRPs 402, 406 of uplink signals transmitted from UE 404. The TRPs 402, 406 measure the UL-RTOA (and optionally UL-SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

A location server may provide a location associated with a device to the device, such as by transmitting location information associated with the device via one or more intermediary servers, network entities, network nodes, or the like. A location server may be able to provide a more accurate location based on more advanced or complicated location technologies compared to a location determined by the device itself. To ensure security and privacy associated with a location request, aspects provided herein may encode information for providing the location into a state token in a location request, and the location server may respond with another state token. By way of example, the state token may include a location history, uncertainties, confidence metrics, historical location related measurements associated with the device (which may include measurements made by the network work device or measurements made by other entities based on signals transmitted by the device), state machine values, probabilities, and aggregations of these values, or the like. The state token may be persisted (e.g., stored) at the device (e.g., or a separate device associated with the device that is not located at the device or the location server) but not the location server, enabling location servers based on state tokens that do not include a device identifier associated with the device.

As used herein, the term “location server” may refer to a collection of one or more servers that may collectively receive a location request associated with a device and provide location information associated with the device to the device or a separate device associated with (e.g., that may be in communication with) the device.

As used herein, the term “location request” may refer to a request transmitted from a device (or another device associated with the device) to a location server to request a location associated with the device. The device may transmit the location request to the location server via one or more intermediaries, such as one or more network nodes, another server, or the like. A transmission may be referred to as “transmitted from the device to the location server” if the transmission originates from the device (or another device associated with the device) and eventually arrives at the location server. In some aspects, a location request may include a state token associated with the device.

As used herein, the term “location response” may refer to a response transmitted from a location server to a device (or another device associated with the device) to provide location information associated with the device. The location server may transmit the location response to the device (or another device associated with the device) via one or more intermediaries, such as one or more network nodes, another server, or the like. A transmission may be referred to as “transmitted from the location server for/to the device” if the transmission originates from the location server and eventually arrives at the device (or another device associated with the device). In some aspects, a location response may include a state token associated with the device. In some aspects, the state token may include location information associated with a device.

As used herein, the term “state token” may refer to a token that includes stateful components of the algorithms used to produce, filter, smooth, debounce, or otherwise adjust a determined location associated with a device. The stateful components may be one or more elements that may include one or more of a last (which may also be referred to as “most recent”) location associated with the device, a last serving cell associated with the device, confidence metrics and uncertainties associated with a calculated device location (or associated with the most recent location), the calculated device location, a last location provided by the location server, one or more accumulated measurement of beacon signals that includes one or more previous geo-spatial positioning results, one or more positions determined based on a positioning mechanism (e.g., and associated confidence metrics or uncertainties), a state ID, a weight associated with samples, calculated device locations, the one or more positions, or the like. In some aspects, a state token may not include an identifier that allows the location server to determine multiple location requests or state tokens to be associated with a same device. In other words, a state token may not include a persistent (e.g., an identifier that can be unchanged after a location request) identifier associated with the device (even if the persistent identifier is generated by a network or a server), such as an international mobile equipment identity (IMEI), permanent equipment identifier (PEI), international mobile subscriber identity (IMSI), a permanent identifier associated with the device, a temporary identifier associated with the device generated for a purpose other than the location request (e.g., an identifier generated by a network entity associated with the core network or the serving cell to facilitate wireless communication), a radio network temporary identifier (RNTI), a temporary mobile subscriber identity (TMS), a globally unique temporary identity (GUTI), or the like. In some aspects, a state token may include a state ID uniquely associated with the state token. In some aspects, the state ID may be generated based on the one or more other elements in the state token. A state ID may be a randomly generated single-use value that served as a key into stateful data, which may also be referred to as “state data.” The state ID may be encoded and may be used by a location server or a device (or another device associated with the device). A new state ID may be generated for every location request and an old state ID may be configured to be discarded after each use (e.g., discarded by the location server after transmitting a response or deleted by the device upon receiving a new state ID associated with a new state token). A state ID does not allow the location server to associate multiple location requests to a single device due to the state ID changes for every location request. By using a state ID, a location server may temporarily store the state token in the event that a device become offline after transmitting a location request, and the location server may transmit a location response after the device come online. In some aspects, an initial location request (a first-in-time location request during a time period that may be configured by the location server) transmitted from the device to the location server may be based on a null state token. A state token may be referred to as a null state token if it does not include information regarding: a most recent location associated with the device, a most recent serving cell associated with the device, an observation variance associated with the device, a location history associated with the device, one or more uncertainties associated with a calculated location, one or more confidence metrics associated with the calculated location, historical location related measurements associated with the device, and one or more state machine values associated with the device. In some aspects, a state token included in a most recently received location response may be included in a subsequent location request from the device to the location server. In some aspects, a state token that is not a null state token may be constructed by the location server but not by the device itself or another device different from the location server. A null state token may be constructed by the device itself or another device different from the location server.

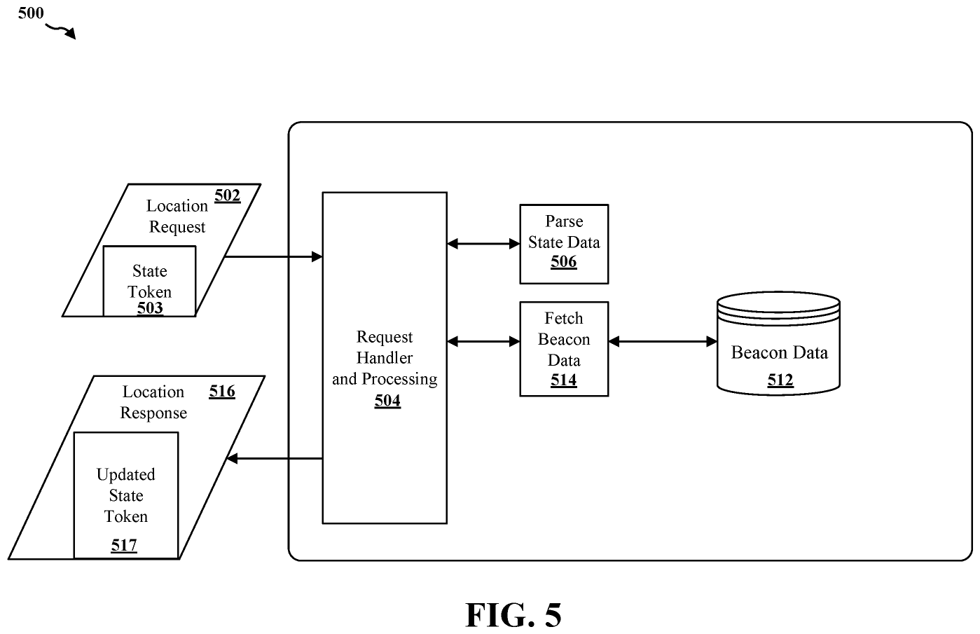

FIG. 5 is a diagram 500 illustrating an example of processing a location request and providing a location response based on a state token. As illustrated in FIG. 5, a location request 502 that includes a state token 503 may be transmitted to a request handler and processing 504 at a location server. The location server may parse state data in the state token 503 at 506, which may parse the one or more elements included in the state token. The state token 503 and the location request 502 may include location related signal measurements associated with a one or more beacons. Based on the location related signal measurements, the server may fetch, at 514, beacon data 512 which may include beacon position data related to the location related signal measurements in order to determine a location. The beacon data 512 may include, by way of example, positions of access points (APs), positions of cell antenna(s), or centroid of coverage of APs and cells for the beacons measured (e.g., by the device or another device). The beacon data 512 may also include GNSS satellite ephemeris data. The beacon data 512 may also include positions of device(s) measuring the beacons. After determining the location information, the location information may be included in an updated state token 517 that may be included in a location response 516 transmitted by the location server for a device (which may be transmitted to the device or another device).

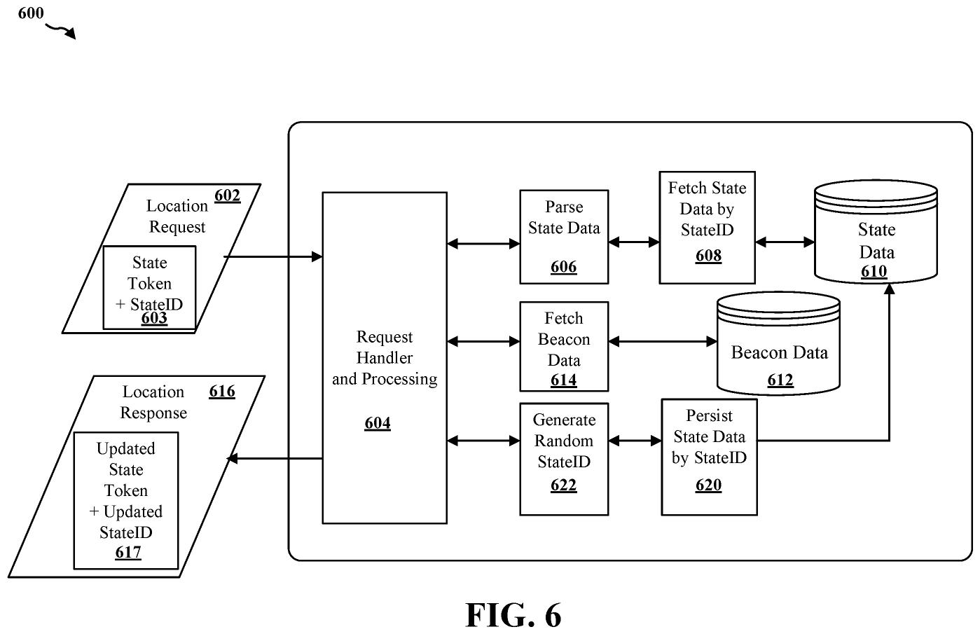

FIG. 6 is a diagram 600 illustrating an example of processing a location request and providing a location response based on a state token including a state ID. As illustrated in FIG. 6, a location request 602 that includes a state token 603 may be transmitted to a request handler and processing 604 at a location server. The state token 603 may include a state ID. The location server may parse state data in the state token 603 at 606, which may parse the one or more elements included in the state token. The state token 603 and the location request 602 may include location related signal measurements associated with a one or more beacons. Based on the location related signal measurements, the server may fetch, at 614, beacon data 612 which may include beacon position data related to the location related signal measurements in order to determine a location. The beacon data 612 may include, by way of example, positions of APs, positions of cell antenna(s), or centroid of coverage of APs and cells for the beacons measured (e.g., by the device or another device). The beacon data 612 may also include GNSS satellite ephemeris data. The beacon data 612 may also include positions of device(s) measuring the beacons. After determining the location information, in some aspects, the location server may generate a state ID at 622 and persist (e.g., temporarily store) the location information as state data 610 at 620 based on the generated state ID. For example, the location server may temporarily store the state data due to a device configured to receive the location response 616 including the state token 617 based on the stored state data may be offline. The location server may temporarily store the state data to wait for the device to come online, fetch state data at 608, then transmit the location response 616 including the state token 617.

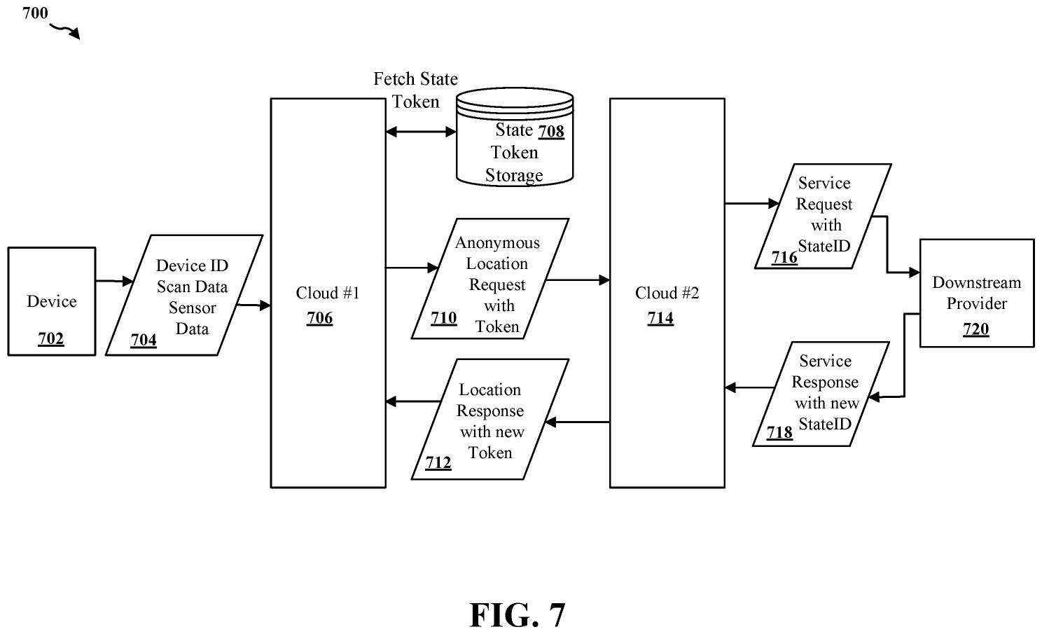

FIG. 7 is a diagram 700 illustrating an example of an architecture associated with providing location information to a device. As illustrated in FIG. 7, the device 702 may provide data 704 including device ID, device scan data, and sensor data to a first cloud server 706 associated with the device 702. The first cloud server 706 may store state token(s) associated with the device 702 at state token storage 708. The first cloud server 706 may transmit location request 710 to a second cloud server 714, which may be part of the location server. The location request 710 may include state token associated with the device 702 and may not include the device ID. Upon receiving the location request 710, the cloud server 714 may transmit a service request 716 with a state ID associated with the state token included in the location request 710 to a downstream provider 720 (e.g., which may be part of the location server) to fetch various location information and may receive a service response 718 associated with a new state ID. The cloud server 714 may transmit a location response 712 based on a new state token generated based on the fetched location information back to the cloud server 706. In some aspects, the downstream provider may be part of the location server and may be connected to the second cloud server 714.

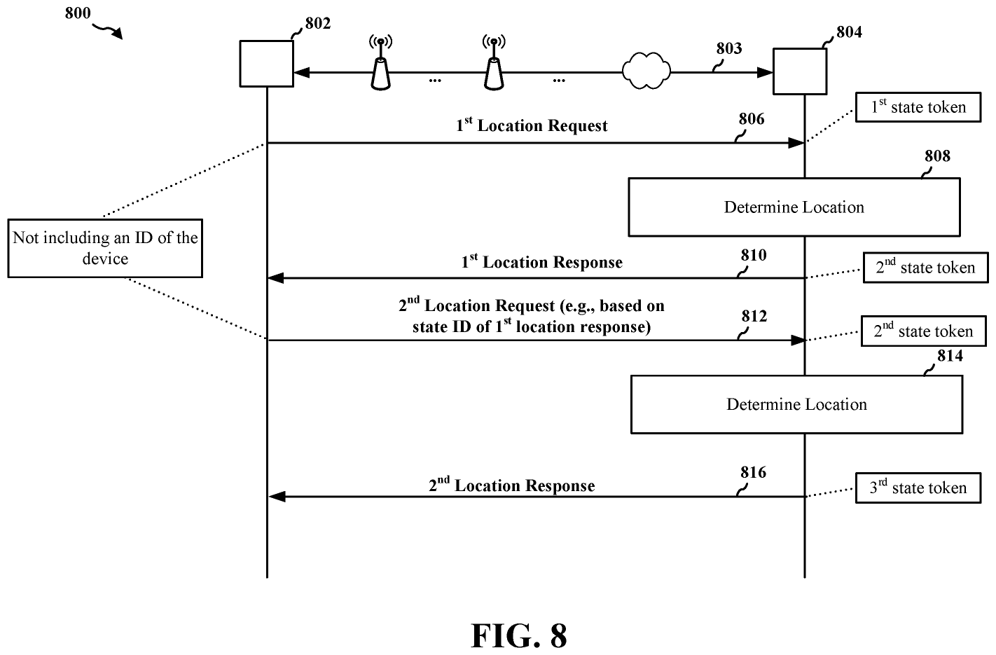

FIG. 8 is a diagram 800 illustrating example communications between a location server 804 and a device 802. As illustrated in FIG. 8, communications between the location server 804 and the device 802 may be facilitated by connection 803 that may be enabled based on one or more other network nodes, network entities, servers, or the like. Communications between the location server 804 and the device 802 may be based on wireless communication, wired communication, or a mixture of wireless communication and wired communication. As illustrated in FIG. 8, the device 802 may transmit a location request 806 to the location server 804 to request location information associated with the device 802. In some aspects, the location request 806 may include a state token and may not include an identifier that may allow the location server 804 to determine multiple location requests or state tokens to be associated with the same device 802. In some aspects, the location request 806 may be a first location request in a configured period of time. In such aspects, the location request 806 may include a null state token. In some aspects, there may be a prior location request/response during the configured period of time. In such aspects, the location request 806 may include a most recently received state token (e.g., in a prior location response). The location request 806 may correspond to the location request 502, the location request 602, or the location request 710. The location response 810 may correspond to the location response 516, the location response 616, or the location response 712.

In some aspects, as previously described, a state token may include one or more elements associated with a device for the purpose of requesting a location. The one or more elements may include one or more of a last (which may also be referred to as “most recent”) location associated with the device, a last serving cell associated with the device, confidence metrics and uncertainties associated with a calculated device location (or associated with the most recent location), the calculated device location, a last location provided by the location server, one or more accumulated measurement of beacon signals that includes one or more previous geo-spatial positioning results, one or more positions determined based on a positioning mechanism (e.g., and associated confidence metrics or uncertainties), a state ID, a weight associated with samples, calculated device locations, the one or more positions, or the like. The state token may not include an identifier that allows the location server 804 to determine multiple location requests or state tokens to be associated with the same device 802.

As illustrated in FIG. 8, at 808, after receiving the location request 806, the location server 804 may determine location information associated with the device 802, such as by parsing state data associated with the state token included in the location request 806 and fetching signal data, as described in connection with FIGS. 5-7. In some aspects, the location server 804 may generate a second state token and transmit the second state token in a first location response 810 for the device 802 (e.g., which may be transmitted to the device 802 or a different device, such as another server). In some aspects, the first state token and the second state token do not include a state ID. In some aspects, the first state token may include a first state ID and the second state token may include a second state ID. A state ID may be generated by the location server 804 and may be uniquely associated with the state token. In some aspects, the location server 804 may delete a received state token in the location request 806 after generating the state token to be transmitted in the location response 810. In some aspects, upon receiving the location response 810 and the second state token, the device 802 (or a device associated with the device 802) may store the second state token.

In some aspects, at some time after receiving the location response 810, the device 802 may transmit a second location request 812 to request updated location information associated with the device 802. In some aspects, the second location request 812 may include the second state token that was previously included in the location response 810 and stored by the device 802. In some aspects, the second location request 812 may also include the second state ID because the second state token includes the second state ID. In some aspects, upon receiving the second location request 812, the location server 804 may again determine location information associated with the device 802 at 814 and may generate a third state token. In some aspects, the location server 804 may delete the second state token upon generating the third state token and may transmit a location response 816 for the device 802 (e.g., which may be transmitted to the device 802 or a different device, such as another server) that includes the third state token. The location request 812 may correspond to the location request 502, the location request 602, or the location request 710. The location response 816 may correspond to the location response 516, the location response 616, or the location response 712.

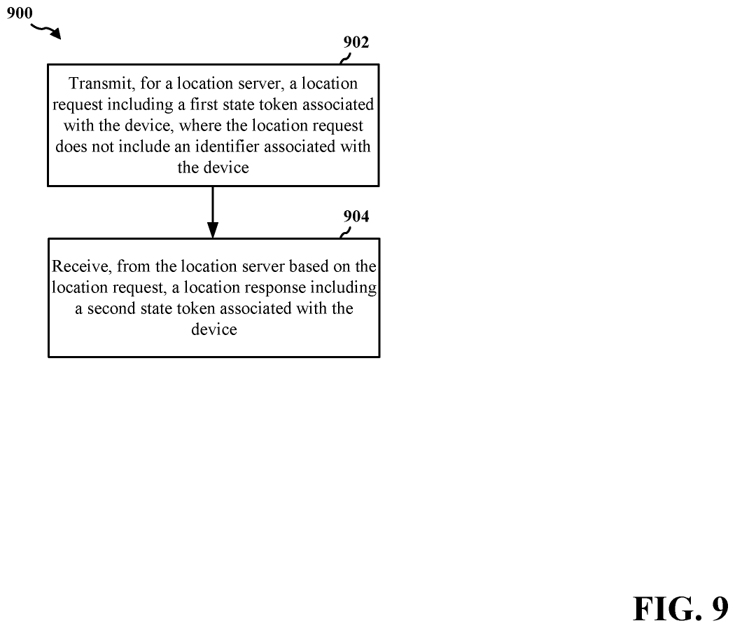

FIG. 9 is a flowchart 900 of a method of providing location information. The method may be performed by a device (e.g., the UE 104, described in connection with FIG. 5 or FIG. 6, the device 702, the device 802; the apparatus 1104). In some aspects, the device may include hardware that enables wireless connectivity based on 5G NR, LTE, LTE-A, CDMA, GSM, Wi-Fi, or other wireless technologies or wired connectivity based on Ethernet or the like.

At 902, the device may transmit, for a location server, a location request including a first state token associated with the device, where the location request does not include an identifier associated with the device. For example, the device 802 may transmit, for a location server 804, a location request (e.g., 806) including a first state token associated with the device, where the location request does not include an identifier associated with the device. In some aspects, 902 may be performed by location component 198. In some aspects, the first state token includes information regarding one or more of: a most recent location associated with the device, a most recent serving cell associated with the device, an observation variance associated with the device, a location history associated with the device, one or more uncertainties associated with a calculated location, one or more confidence metrics associated with the calculated location, historical location related measurements associated with the device (which may include measurements made by the network work device or measurements made by other entities based on signals transmitted by the device), or one or more state machine values associated with the device. In some aspects, the first state token includes a state ID, and where the state ID is based on a prior location response before the location response. In some aspects, the identifier is a value that allows the location server to identify and associate more than one location requests with the device. In other words, the location request may not include a value that allows the location server to identify and associate more than one location requests with the device. In some aspects, the first state token does not include information regarding: a most recent location associated with the device, a most recent serving cell associated with the device, an observation variance associated with the device, a location history associated with the device, one or more uncertainties associated with a calculated location, one or more confidence metrics associated with the calculated location, historical location related measurements associated with the device, or one or more state machine values associated with the device. A state token that does not include such information may be a null token. For example, during if the location request is a first-ever location request to the location server, the first state token may be a null token.

At 904, the device may receive, from the location server based on the location request, a location response including a second state token associated with the device. For example, the device 802 may receive, from the location server 804 based on the location request 806, a location response 810 including a second state token associated with the device. In some aspects, 904 may be performed by location component 198. In some aspects, the second state token includes information regarding one or more of: a most recent location associated with the device, a most recent serving cell associated with the device, an observation variance associated with the device, a location history associated with the device, one or more uncertainties associated with a calculated location, one or more confidence metrics associated with the calculated location, historical location related measurements associated with the device, or one or more state machine values associated with the device. In some aspects, the second state token includes a second state ID.

In some aspects, the device may transmit, for the location server, a second location request including the second state token associated with the device. For example, the device 802 may transmit, for the location server 804, a second location request 812 including the second state token (e.g., which includes the second state ID) associated with the device. In some aspects, the device 802 may receive, from the location server based on the second location request, a second location response including a third state token associated with the device, the third state token including a third state ID.

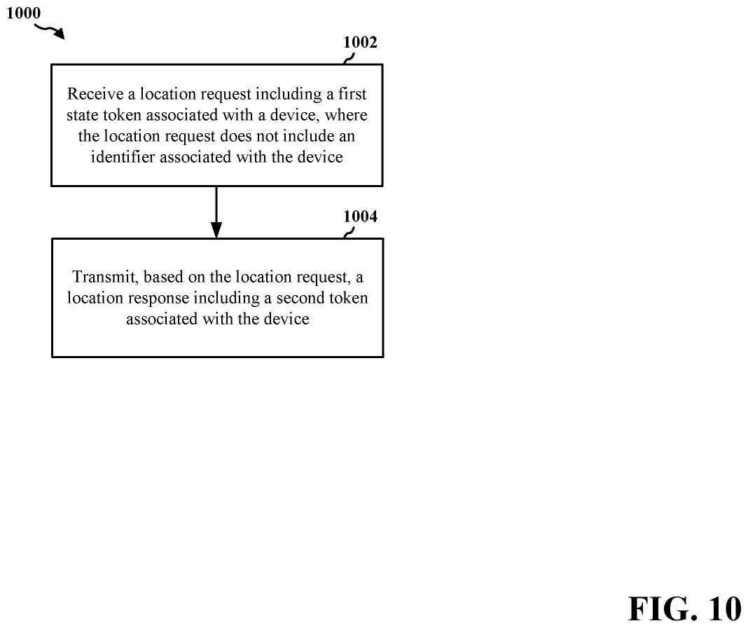

FIG. 10 is a flowchart 1000 of a method of providing location information. The method may be performed by a location server (e.g., a location server in communication with the base station 102, the network entity 1102, or the network entity 1202, the location server described in connection with FIG. 5 or FIG. 6, cloud server 714, or the location server 804).

At 1002, the location server may receive, a location request including a first state token associated with the device, where the location request does not include an identifier associated with the device. For example, the location server 804 may receive, a location request 806 including a first state token associated with a device 802, where the location request does not include an identifier associated with the device. In some aspects, 1002 may be performed by location component 199. In some aspects, the first state token includes information regarding one or more of: a most recent location associated with the device, a most recent serving cell associated with the device, an observation variance associated with the device, a location history associated with the device, one or more uncertainties associated with a calculated location, one or more confidence metrics associated with the calculated location, historical location related measurements associated with the device, or one or more state machine values associated with the device. In some aspects, the first state token includes a state ID, and where the state ID is based on a prior location response before the location response. In some aspects, the identifier is a value that allows the location server to identify and associate more than one location requests with the device. In other words, the location request may not include a value that allows the location server to identify and associate more than one location requests with the device. In some aspects, the first state token does not include information regarding: a most recent location associated with the device, a most recent serving cell associated with the device, an observation variance associated with the device, a location history associated with the device, one or more uncertainties associated with a calculated location, one or more confidence metrics associated with the calculated location, historical location related measurements associated with the device, or one or more state machine values associated with the device. A state token that does not include such information may be a null token. For example, during if the location request is a first-ever location request to the location server, the first state token may be a null token.

At 1004, the location server may transmit, based on the location request, a location response including a second token associated with the device. For example, the location server 804 may transmit, based on the location request 806, a location response 810 including a second token associated with the device. In some aspects, 1004 may be performed by location component 199. In some aspects, the location server may generate the second state token including a second state ID, maintain the second state ID and the second state token before transmission of the location response, and delete the first state ID after generation of the second state ID. In some aspects, such as in aspects where the device may be offline, the location server may store the second state token and the second state ID for a period of time until the device come online.

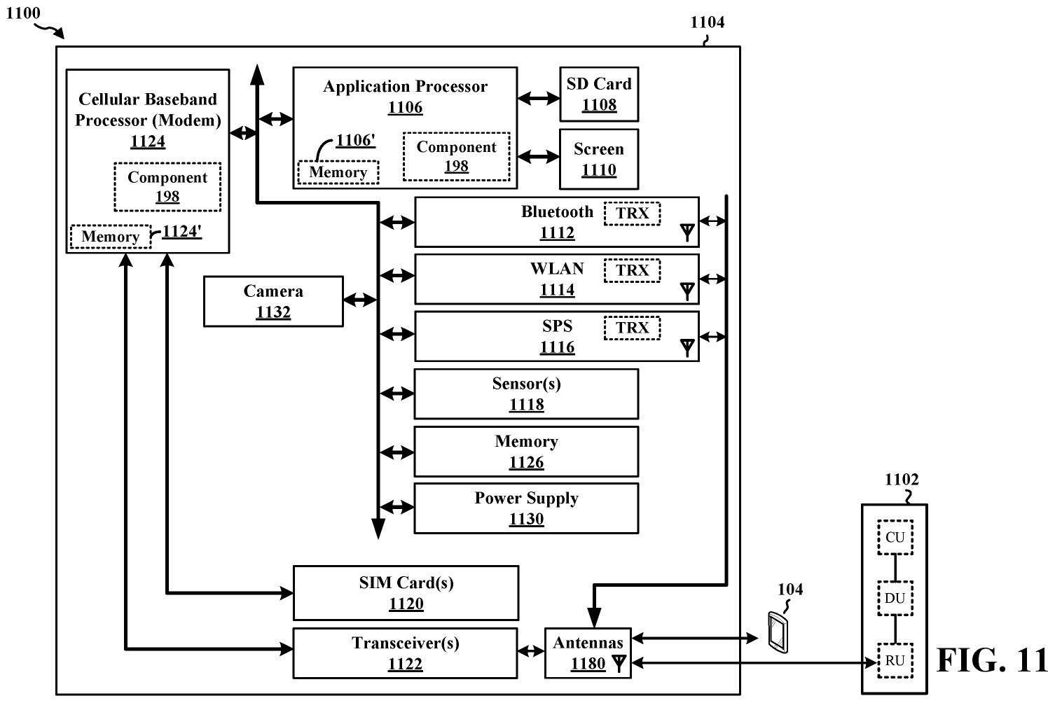

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include at least one cellular baseband processor 1124 (also referred to as a modem) coupled to one or more transceivers 1122 (e.g., cellular RF transceiver). The cellular baseband processor(s) 1124 may include at least one on-chip memory 1124′. In some aspects, the apparatus 1104 may further include one or more subscriber identity modules (SIM) cards 1120 and at least one application processor 1106 coupled to a secure digital (SD) card 1108 and a screen 1110. The application processor(s) 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor(s) 1124 communicates through the transceiver(s) 1122 via one or more antennas 1180 with the UE 104 and/or with an RU associated with a network entity 1102. The cellular baseband processor(s) 1124 and the application processor(s) 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor(s) 1124 and the application processor(s) 1106 are each responsible for general processing, including the execution of software stored on the computer-readable medium/memory. The software, when executed by the cellular baseband processor(s) 1124/application processor(s) 1106, causes the cellular baseband processor(s) 1124/application processor(s) 1106 to perform the various functions described supra. The computer-readable medium/memory may also be used for storing data that is manipulated by the cellular baseband processor(s) 1124/application processor(s) 1106 when executing software. The cellular baseband processor(s) 1124/application processor(s) 1106 may be a component of the UE 350 and may include the at least one memory 360 and/or at least one of the TX processor 368, the RX processor 356, and the controller/processor 359. In one configuration, the apparatus 1104 may be at least one processor chip (modem and/or application) and include just the cellular baseband processor(s) 1124 and/or the application processor(s) 1106, and in another configuration, the apparatus 1104 may be the entire UE (e.g., see UE 350 of FIG. 3) and include the additional modules of the apparatus 1104.

As discussed supra, the location component 198 may be configured to transmit, for a location server, a location request including a first state token associated with the device, where the location request does not include an identifier associated with the device. In some aspects, the location component 198 may be further configured to receive, from the location server based on the location request, a location response including a second state token associated with the device. The location component 198 may be within the cellular baseband processor(s) 1124, the application processor(s) 1106, or both the cellular baseband processor(s) 1124 and the application processor(s) 1106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1104 may include a variety of components configured for various functions. In one configuration, the apparatus 1104, and in particular the cellular baseband processor(s) 1124 and/or the application processor(s) 1106, may include means for transmitting, for a location server, a location request including a first state token associated with the device, where the location request does not include an identifier associated with the device. In some aspects, the apparatus 1104 may include means for receiving, from the location server based on the location request, a location response including a second state token associated with the device. In some aspects, the apparatus 1104 may include means for transmitting, for the location server, a second location request including the second state token associated with the device. In some aspects, the apparatus 1104 may include means for receiving, from the location server based on the second location request, a second location response including a third state token associated with the device, the third state token including a third state ID. The means may be the component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

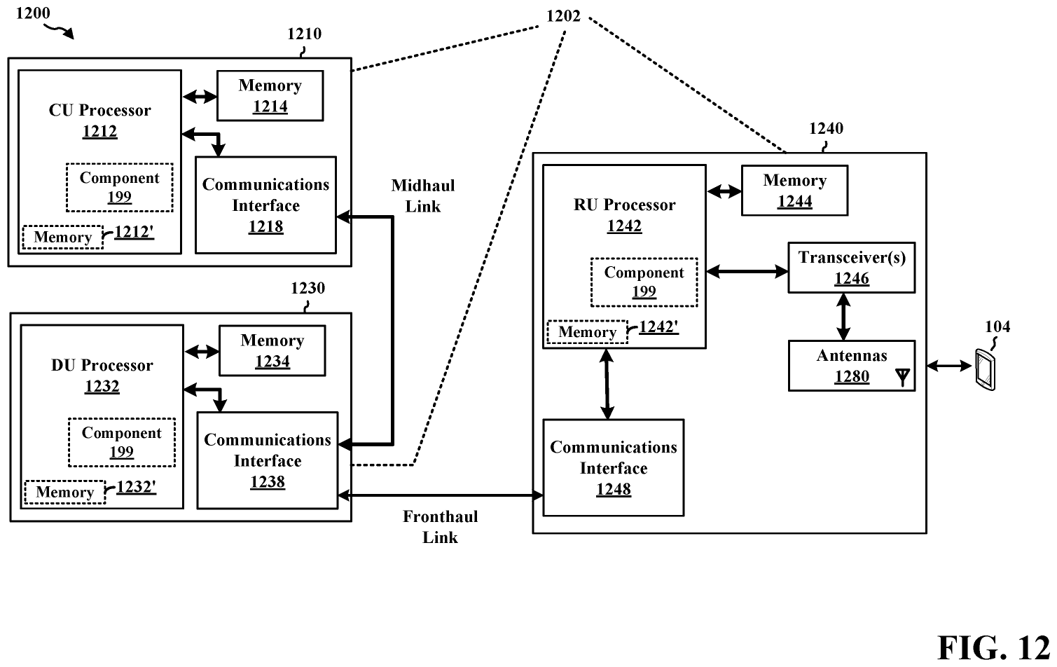

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include at least one CU processor 1212. The CU processor(s) 1212 may include on-chip memory 1212′. In some aspects, the CU 1210 may further include additional memory modules 1214 and a communications interface 1218. The CU 1210 communicates with the DU 1230 through a midhaul link, such as an F1 interface. The DU 1230 may include at least one DU processor 1232. The DU processor(s) 1232 may include on-chip memory 1232′. In some aspects, the DU 1230 may further include additional memory modules 1234 and a communications interface 1238. The DU 1230 communicates with the RU 1240 through a fronthaul link. The RU 1240 may include at least one RU processor 1242. The RU processor(s) 1242 may include on-chip memory 1242′. In some aspects, the RU 1240 may further include additional memory modules 1244, one or more transceivers 1246, antennas 1280, and a communications interface 1248. The RU 1240 communicates with the UE 104. The on-chip memory 1212′, 1232′, 1242′ and the additional memory modules 1214, 1234, 1244 may each be considered a computer-readable medium/memory. Each computer-readable medium/memory may be non-transitory. Each of the processors 1212, 1232, 1242 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the location component 199 may be configured to receive, a location request including a first state token associated with a device, where the location request does not include an identifier associated with the device. In some aspects, the location component 199 may be further configured to transmit, based on the location request, a location response including a second token associated with the device. The location component 199 may be within one or more processors of one or more of the CU 1210, DU 1230, and the RU 1240. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1202 may include a variety of components configured for various functions. In one configuration, the network entity 1202 may include means for receiving a location request including a first state token associated with a device, where the location request does not include an identifier associated with the device. In some aspects, the network entity 1202 may include means for transmitting, for the device based on the location request, a location response including a second token associated with the device. In some aspects, the network entity 1202 may include means for generating the second state token including a second state ID. In some aspects, the network entity 1202 may include means for maintaining the second state ID and the second state token before transmission of the location response. In some aspects, the network entity 1202 may include means for deleting the first state ID after generation of the second state ID. The means may be the component 199 of the network entity 1202 configured to perform the functions recited by the means. As described supra, the network entity 1202 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method performed by an apparatus associated with a device, including: transmitting, for a location server, a location request including a first state token associated with the device, where the location request does not include an identifier associated with the device; and receiving, from the location server based on the location request, a location response including a second state token associated with the device.

Aspect 2 is the method of aspect 1, where the first state token includes information regarding one or more of: a most recent location associated with the device, a most recent serving cell associated with the device, an observation variance associated with the device, a location history associated with the device, one or more uncertainties associated with a calculated location, one or more confidence metrics associated with the calculated location, historical location related measurements associated with the device, or one or more state machine values associated with the device.

Aspect 3 is the method of any of aspects 1-2, where the second state token includes information regarding one or more of: a most recent location associated with the device, a most recent serving cell associated with the device, an observation variance associated with the device, a location history associated with the device, one or more uncertainties associated with a calculated location, one or more confidence metrics associated with the calculated location, historical location related measurements associated with the device, or one or more state machine values associated with the device.

Aspect 4 is the method of any of aspects 1-3, where the first state token includes a state identifier (ID), and where the state ID is based on a prior location response before the location response.

Aspect 5 is the method of aspect 4, where the second state token includes a second state ID, and further including: transmitting, for the location server, a second location request including the second state token associated with the device; and receiving, from the location server based on the second location request, a second location response including a third state token associated with the device, the third state token including a third state ID.

Aspect 6 is the method of any of aspects 1-5, where the identifier is a value that allows the location server to identify and associate more than one location requests with the device.

Aspect 7 is the method of any of aspects 1 or 3-6, where the first state token does not include information regarding: a most recent location associated with the device, a most recent serving cell associated with the device, an observation variance associated with the device, a location history associated with the device, one or more uncertainties associated with a calculated location, one or more confidence metrics associated with the calculated location, historical location related measurements associated with the device, or one or more state machine values associated with the device.

Aspect 8 is a method performed by a location server, including: receiving, from a device, a location request including a first state token associated with the device, where the location request does not include an identifier associated with the device; and transmitting, based on the location request, a location response including a second state token associated with the device.

Aspect 9 is the method of aspect 8, where the first state token includes information regarding one or more of: a most recent location associated with the device, a most recent serving cell associated with the device, an observation variance associated with the device, a location history associated with the device, one or more uncertainties associated with a calculated location, one or more confidence metrics associated with the device, historical location related measurements associated with the device, or one or more state machine values associated with the device.

Aspect 10 is the method of any of aspects 8-9, where the second state token includes information regarding one or more of: a most recent location associated with the device, a most recent serving cell associated with the device, an observation variance associated with the device, a location history associated with the device, one or more uncertainties associated with a calculated location, one or more confidence metrics associated with the device, historical location related measurements associated with the device, or one or more state machine values associated with the device.

Aspect 11 is the method of any of aspects 8-10, where the first state token includes a state identifier (ID), and where the state ID is based on a prior location response before the location response.

Aspect 12 is the method of any of aspects 8-11, further including: generating the second state token including a second state ID; maintaining the second state ID and the second state token before transmission of the location response; and deleting the state ID after generation of the second state ID.

Aspect 13 is the method of any of aspects 8 or 10-12, where the identifier is a value that allows the location server to identify and associate more than one location requests with the device.

Aspect 14 is an apparatus at a device including at least one memory and at least one processor coupled to the at least one memory and, the at least one processor, individually or in any combination, based at least in part on information stored in the at least one memory, the at least one processor is configured to implement any of aspects 1 to 7.

Aspect 15 is the apparatus of aspect 14, further including one or more transceivers or one or more antennas coupled to the at least one processor.

Aspect 16 is an apparatus at a device including means for implementing any of aspects 1 to 7.

Aspect 17 is a computer-readable medium (e.g., a non-transitory computer-readable medium) storing computer executable code, where the code when executed by at least one processor causes the at least one processor to implement any of aspects 1 to 7.

Aspect 18 is an apparatus at a device including at least one memory and at least one processor coupled to the at least one memory and, the at least one processor, individually or in any combination, based at least in part on information stored in the at least one memory, the at least one processor is configured to implement any of aspects 8 to 13.

Aspect 19 is the apparatus of aspect 18, further including one or more transceivers or one or more antennas coupled to the at least one processor.

Aspect 20 is an apparatus at a device including means for implementing any of aspects 8 to 13.

Aspect 21 is a computer-readable medium (e.g., a non-transitory computer-readable medium) storing computer executable code, where the code when executed by at least one processor causes the at least one processor to implement any of aspects 8 to 13.

What is claimed is:

1. An apparatus associated with a device, comprising:
at least one memory; and
at least one processor coupled to the at least one memory and, based at least in part on information stored in the at least one memory, the at least one processor, individually or in any combination, is configured to:
transmit, for a location server, a location request including a first state token associated with the device, wherein the location request does not include an identifier associated with the device; and
receive, from the location server based on the location request, a location response including a second state token associated with the device.

2. The apparatus of claim 1, wherein the first state token comprises information regarding one or more of: a most recent location associated with the device, a most recent serving cell associated with the device, an observation variance associated with the device, a location history associated with the device, one or more uncertainties associated with a calculated location, one or more confidence metrics associated with the calculated location, historical location related measurements associated with the device, or one or more state machine values associated with the device.

3. The apparatus of claim 1, wherein the second state token comprises information regarding one or more of: a most recent location associated with the device, a most recent serving cell associated with the device, an observation variance associated with the device, a location history associated with the device, one or more uncertainties associated with a calculated location, one or more confidence metrics associated with the calculated location, historical location related measurements associated with the device, or one or more state machine values associated with the device.

4. The apparatus of claim 1, wherein the first state token comprises a state identifier (ID), and wherein the state ID is based on a prior location response before the location response.

5. The apparatus of claim 4, wherein the second state token comprises a second state ID, and wherein the at least one processor, individually or in any combination, is further configured to:
transmit, for the location server, a second location request including the second state token associated with the device; and
receive, from the location server based on the second location request, a second location response including a third state token associated with the device, the third state token comprising a third state ID.

6. The apparatus of claim 1, wherein the identifier is a value that allows the location server to identify and associate more than one location requests with the device.

7. The apparatus of claim 1, wherein the first state token does not comprise information regarding: a most recent location associated with the device, a most recent serving cell associated with the device, an observation variance associated with the device, a location history associated with the device, one or more uncertainties associated with a calculated location, one or more confidence metrics associated with the calculated location, historical location related measurements associated with the device, or one or more state machine values associated with the device.

8. The apparatus of claim 1, further comprising at least one of a transceiver or an antenna coupled to the at least one processor, wherein to transmit the location request, the at least one processor, individually or in any combination, is configured to transmit the location request via at least one of the transceiver or the antenna.

9. An apparatus at a location server, comprising:
at least one memory; and
at least one processor coupled to the at least one memory and, based at least in part on information stored in the at least one memory, the at least one processor, individually or in any combination, is configured to:
receive a location request including a first state token associated with a device, wherein the location request does not include an identifier associated with the device; and
transmit, based on the location request, a location response including a second state token associated with the device.

10. The apparatus of claim 9, wherein the first state token comprises information regarding one or more of: a most recent location associated with the device, a most recent serving cell associated with the device, an observation variance associated with the device, a location history associated with the device, one or more uncertainties associated with a calculated location, one or more confidence metrics associated with the device, historical location related measurements associated with the device, or one or more state machine values associated with the device.

11. The apparatus of claim 9, wherein the second state token comprises information regarding one or more of: a most recent location associated with the device, a most recent serving cell associated with the device, an observation variance associated with the device, a location history associated with the device, one or more uncertainties associated with a calculated location, one or more confidence metrics associated with the device, historical location related measurements associated with the device, or one or more state machine values associated with the device.

12. The apparatus of claim 9, wherein the first state token comprises a state identifier (ID), and wherein the state ID is based on a prior location response before the location response.

13. The apparatus of claim 12, wherein the at least one processor, individually or in any combination, is further configured to:
generate the second state token comprising a second state ID;
maintain the second state ID and the second state token before transmission of the location response; and
delete the state ID after generation of the second state ID.

14. The apparatus of claim 9, wherein the identifier is a value that allows the location server to identify and associate more than one location requests with the device.

15. The apparatus of claim 9, further comprising at least one of a transceiver or an antenna coupled to the at least one processor, wherein to receive the location request, the at least one processor, individually or in any combination, is configured to receive the location request via at least one of the transceiver or the antenna.

16. A method performed by an apparatus associated with a device, comprising:
transmitting, for a location server, a location request including a first state token associated with the device, wherein the location request does not include an identifier associated with the device; and
receiving, from the location server based on the location request, a location response including a second state token associated with the device.

17. The method of claim 16, wherein the first state token comprises information regarding one or more of: a most recent location associated with the device, a most recent serving cell associated with the device, an observation variance associated with the device, a location history associated with the device, one or more uncertainties associated with a calculated location, one or more confidence metrics associated with the calculated location, historical location related measurements associated with the device, or one or more state machine values associated with the device.

18. The method of claim 16, wherein the second state token comprises information regarding one or more of: a most recent location associated with the device, a most recent serving cell associated with the device, an observation variance associated with the device, a location history associated with the device, one or more uncertainties associated with a calculated location, one or more confidence metrics associated with the calculated location, historical location related measurements associated with the device, or one or more state machine values associated with the device.

19. The method of claim 16, wherein the first state token comprises a state identifier (ID), and wherein the state ID is based on a prior location response before the location response.

20. The method of claim 19, wherein the second state token comprises a second state ID, and further comprising:
transmitting, for the location server, a second location request including the second state token associated with the device; and
receiving, from the location server based on the second location request, a second location response including a third state token associated with the device, the third state token comprising a third state ID.

21. The method of claim 16, wherein the identifier is a value that allows the location server to identify and associate more than one location requests with the device.

22. The method of claim 16, wherein the first state token does not comprise information regarding: a most recent location associated with the device, a most recent serving cell associated with the device, an observation variance associated with the device, a location history associated with the device, one or more uncertainties associated with a calculated location, one or more confidence metrics associated with the calculated location, historical location related measurements associated with the device, or one or more state machine values associated with the device.

23. A method performed by a location server, comprising:
receiving, from a device, a location request including a first state token associated with the device, wherein the location request does not include an identifier associated with the device; and
transmitting, based on the location request, a location response including a second state token associated with the device.

24. The method of claim 23, wherein the first state token comprises information regarding one or more of: a most recent location associated with the device, a most recent serving cell associated with the device, an observation variance associated with the device, a location history associated with the device, one or more uncertainties associated with a calculated location, one or more confidence metrics associated with the device, historical location related measurements associated with the device, or one or more state machine values associated with the device.

25. The method of claim 23, wherein the second state token comprises information regarding one or more of: a most recent location associated with the device, a most recent serving cell associated with the device, an observation variance associated with the device, a location history associated with the device, one or more uncertainties associated with a calculated location, one or more confidence metrics associated with the device, historical location related measurements associated with the device, or one or more state machine values associated with the device.

26. The method of claim 23, wherein the first state token comprises a state identifier (ID), and wherein the state ID is based on a prior location response before the location response.

27. The method of claim 26, further comprising:
generating the second state token comprising a second state ID;
maintaining the second state ID and the second state token before transmission of the location response; and
deleting the state ID after generation of the second state ID.

28. The method of claim 23, wherein the identifier is a value that allows the location server to identify and associate more than one location requests with the device.
